(19) United States
(12) Patent Application Publication
(10) Pub. No.: US 2016/0158850 A1
(43) Pub. Date: Jun. 9, 2016

(54) DRILLING JIG

(71) Applicant: BRAND DEVELOPERS AUST PTY LTD, Victoria (AU)

(72) Inventor: James Fisher, Auckland (NZ)

(73) Assignee: Brand Developers Aust Pty Ltd, Victoria (AU)

(21) Appl. No.: 14/907,024

(22) PCT Filed: Jul. 18, 2014
(86) PCT No.: PCT/AU2014/000741

§ 371 Date: Jan. 22, 2016

(30) Foreign Application Priority Data
Aug. 1, 2013 (AU) 2013902861

(51) Int. Cl. B23B 49/02; B25B 5/14; B25B 5/06

(52) U.S. Cl. CPC B23B 49/02; B25B 5/068; B25B 5/145; B23B 2247/10; B23B 2260/03

(57) ABSTRACT

Disclosed herein is a clamping device that can take the form of a drilling jig, which may be used to join objects arranged at an angle to each other. The drilling jig can include an upstand and a clamping handle that can be configured such that in use, an object, such as a piece of wood, is able to be clamped between the upstand and the clamping handle.

### TECHNICAL FIELD

A clamping device is disclosed that takes the form of a drilling jig, used for joining objects at an angle. The drilling jig can be configured such that, in use, an object, such as a piece of wood, is able to be clamped therein for ease of drilling.

### BACKGROUND ART

Wooden boards are joined at angles when manufacturing frames, cabinets, chairs, tables and in other forms of carpentry. To join wooden boards together on an angle, a drill guide, or drilling jig, can be employed to drill holes through which fasteners can be introduced. Drilling jigs may have two fixed holes at a set distance apart. This arrangement does not allow for the varied spacing of fastening holes and does not allow for wooden boards to be simply accommodated when being fixed at an angle.

U.S. Pat. No. 6,481,937 (Sommerfield) discloses an attempted solution to allow for increased flexibility when fastening wooden boards together and at an angle. Sommerfield discloses the use of a drilling jig with an adjustable guide fixed to a clamping device. However, the clamping device disclosed by Sommerfield needs to be manually adjusted to accommodate wooden objects of varying widths.

The above references to the background art do not constitute an admission that the art forms a part of the common general knowledge of a person of ordinary skill in the art. The above references are also not intended to limit the application of the apparatus as disclosed herein.

### SUMMARY OF THE DISCLOSURE

Disclosed herein is a clamping device. The clamping device can take the form of a drilling jig, which may be used to join objects arranged at an angle to each other. In at least one embodiment, the clamping device comprises a first member, a second member slideably movable with respect to the first member, the first and second members configured such that in use an object is able to be clamped between them. The slidable second member can accommodate wooden objects of varying widths without, for each different width object, requiring manual adjustment of the clamping device.

The clamping device may also include a guide member comprising at least one channel for receiving a drill bit, the channel able to direct the drill bit to the object when clamped between the first and second members.

In at least one embodiment, the second member may be mounted to a slide bar. This can allow for its ease of deployment and adjustment in use.

In at least one embodiment, the second member may comprise a clamping body and may comprise a handle. The handle can be pivotally mounted to the clamping body such that a pivoting force applied to the handle causes the second member to slide along the slide bar towards a first end of the slide bar. The handle can provide leverage and mechanical advantage for a greater and more secure clamping effect.

In at least one embodiment, the clamping device may further comprise a drive mechanism. The drive mechanism can releasably engage the slide bar and can cooperate with the handle. The releasable engagement of the drive mechanism may be such that, when the handle is released, the drive mechanism can be disengaged from the slide bar. When the handle is pivoted by the pivoting force, the drive mechanism may be caused by the handle to engage with the slide bar whereby the clamping body is caused to be advanced towards the first end of the slide bar. Thus, the drive mechanism can provide further actuation to the second member to enhance clamping and release actions.

In at least one embodiment, the drive mechanism may be located within a first cavity in the clamping body. In other words, the drive mechanism may be concealed within the clamping device.

In at least one embodiment, the drive mechanism may comprise a spring and may comprise one or more friction plates. The spring can be arranged to bias the plates out of frictional engagement with the slide bar. The spring may be displaceable such that, when the handle is pivoted, the friction plates are brought into engagement with the slide bar. The spring and plates can thereby provide a simple mechanism for slide bar engagement.

In at least one embodiment, the clamping device may further comprise a stop mechanism that is configured to engage with the slide bar so as to resist movement of the second member towards a second end of the slide bar. The resistance to movement provided by the stop mechanism can facilitate clamping of the object between the first and second members.

In at least one embodiment, the clamping device may further comprise a release mechanism. The release mechanism can be arranged to act on the stop mechanism whereby, when the release mechanism is actuated, it can cause the stop mechanism to disengage from the slide bar so that movement of the second member towards the second end is enabled.

In at least one embodiment, the stop mechanism may comprise a spring and a clutch plate. In this embodiment, the release mechanism may comprise an extension of the clutch plate and a pivot. The spring can be arranged to bias the clutch plate into frictional engagement with the slide bar to prevent movement of the second member to the slide bar second end. The spring can be displaceable by pivotal movement of the clutch plate extension about the pivot whereby the clutch plate is released from frictional engagement with the slide bar so as to allow the movement of the second member to the slide bar second end. Again, the spring and clutch plate can provide a simple mechanism for slide bar engagement.

In this embodiment, the release mechanism may be arranged such that, when actuated, it causes the stop mechanism to pivot out of engagement with the slide bar to allow for movement of the second member towards the second end of the slide bar.

In at least one embodiment, the stop mechanism may be located within a second cavity in the clamping body. In other words, the stop mechanism may be concealed within the clamping device.

In at least one embodiment, the at least one channel may be angularly disposed within the guide. This can allow for e.g. the fastening of wooden boards together and at an angle.

In some forms, the clamping device may further comprise a base for location on a surface (e.g. a workbench). The base may comprise a clamping surface to allow for the clamping device to be clamped to a work surface (e.g. of a workbench).

The base may comprise a recess, the slide bar being located within the recess. Again, this can provide for a neat and ergonomic finish to the clamping device. The base may comprise another recess for holding a drill bit (e.g. to be used with the jig).

In some forms, the first member may comprise (or be defined by) a projecting wall upstanding from the base. In this embodiment, the guide member may be adjustably mounted to the projecting wall whereby the height of a lower exit end of the channel can be moved with respect to the base. This can e.g. adjust for different thicknesses of boards to be drilled for subsequent fastening together.

### BRIEF DESCRIPTION OF THE DRAWINGS

Notwithstanding any other forms which may fall within the scope of the clamping deice as set forth in the Summary, further embodiments of the clamping device will now be provided in the following description, which is given by way of example only and with reference to the accompanying drawings in which:

FIG. 1 shows a cross section through the drilling jig with the driving mechanism in a disengaged position;

FIG. 2 shows a perspective view of the drilling jig with the driving mechanism in a disengaged position;

FIG. 3 shows a cross section through the drilling jig with the driving mechanism in an engaged position;

FIG. 4 shows a perspective view of the handle;

FIG. 5 shows a perspective view of the clamping body;

FIG. 6a shows a top view of the friction plates;

FIG. 6b shows a side view of the friction plates;

FIG. 7a shows a top view of the clutch plate and release mechanism;

FIG. 7b shows a side view of the clutch plate and release mechanism; and

FIG. 8 shows a perspective view of the base.

### DETAILED DESCRIPTION OF SPECIFIC EMBODIMENTS

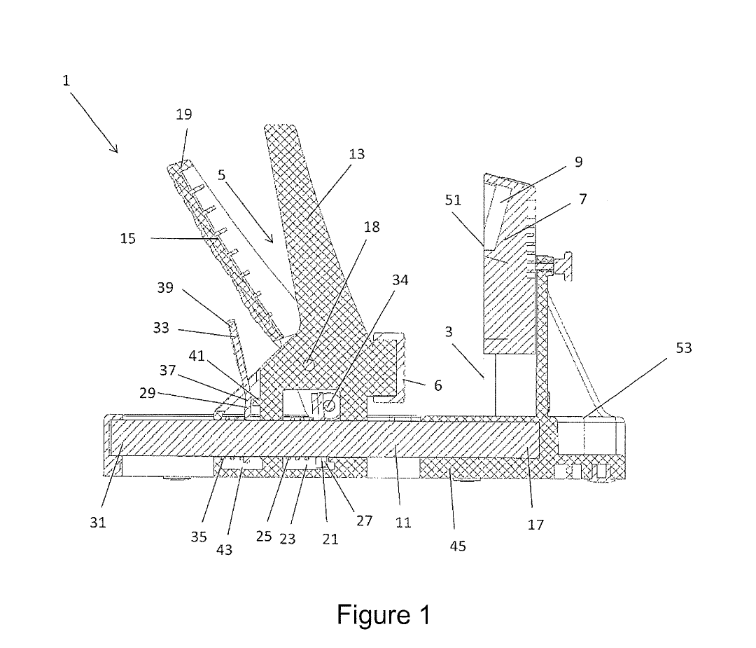

Referring firstly to FIG. 1, a clamping device is shown in the form of a drilling jig 1. The drilling jig comprises a first member, in the form of an upstand 3, and a second member, in the form of a clamping handle 5. The upstand 3 and the clamping handle 5 also form the clamping surfaces in this embodiment. The clamping handle 5 is slideably movable with respect to the upstand 3. The upstand 3 and the clamping handle 5 are configured such that in use, an object, such as a piece of wood, is able to be clamped between the clamping surfaces of the upstand 3 and the clamping handle 5.

The drilling jig 1 also comprises a guide member 7. The guide member 7 comprises at least one channel 9 for receiving a drill bit. The channel 9 is positioned such that it is able to direct a drill bit towards the object when clamped between the upstand 3 and the clamping handle 5. The clamping handle 5 is mounted to a slide bar 11 to allow for slidable movement of the clamping handle 5. The slidable mounting of the clamping handle 5 with respect to the upstand allows for simple adjustability of the drilling rig 1. For example, varying width of an object clamped in the drilling rig 1 may be easily accommodated for by sliding the clamping handle 5 into a new clamped position. This is to be contrasted with known devices, which require manual readjustment of the clamping components every time a newly/differently dimensioned object is to be clamped therewithin.

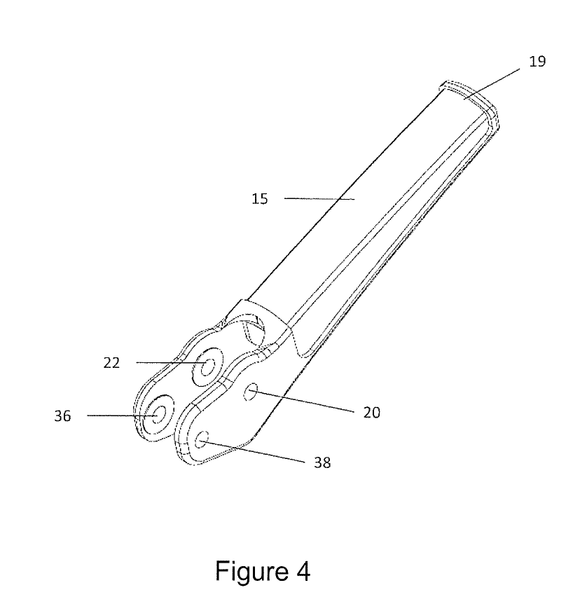

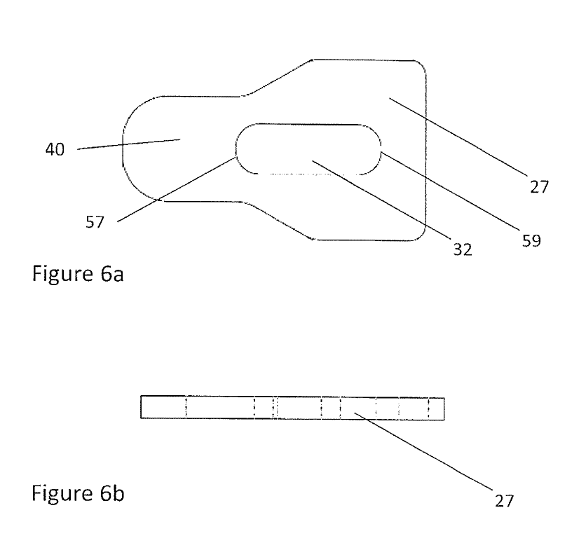

Referring now to FIGS. 1 to 8, the drilling jig 1 will now be described in greater detail. The clamping handle 5 comprises a clamping body 13 and a handle 15, the handle 15 being pivotally mounted to the clamping body 13. The clamping body includes a projection 6 that forms the clamping surface of the clamping handle 5. The pivotal mounting between the clamping body 13 and the handle 15, in the form of a pin 18, is positioned between openings 20 and 22 in the handle 15, as detailed in FIG. 4. The clamping body 13 and the handle 15 are pivotally mounted such that a pivoting force applied to the handle 15 causes the clamping handle 5 to slide along the slide bar 11 towards a first end 17 of the slide bar 11. The pivoting force is produced by a user gripping both the clamping body 13 and the handle 15 in one hand and squeezing the two together. The squeezing of the handle 15 and the clamping body 13 together pushes the end 19 of the clamping handle 15 towards the clamping body 13.

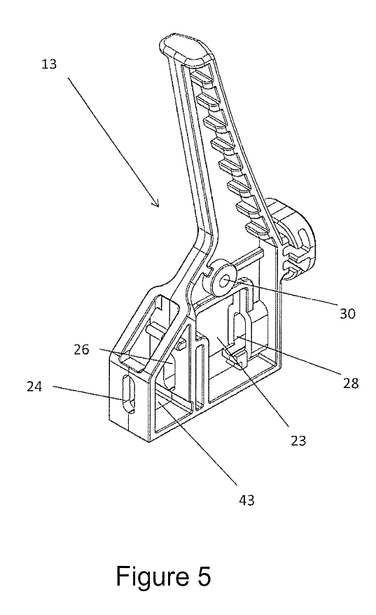

Referring now to FIG. 5, the clamping body 13 is described in more detail. The clamping body 13 comprises two cavities 23 and 43. The clamping body 13 also comprises three openings 24, 26 and 28 for receiving the slide bar 11. The clamping body 13 further comprises an opening 30 that is positioned between the openings 20 and 22 of the handle 15, through which a pin is placed to pivotally mount the handle 15 to the clamping body 13.

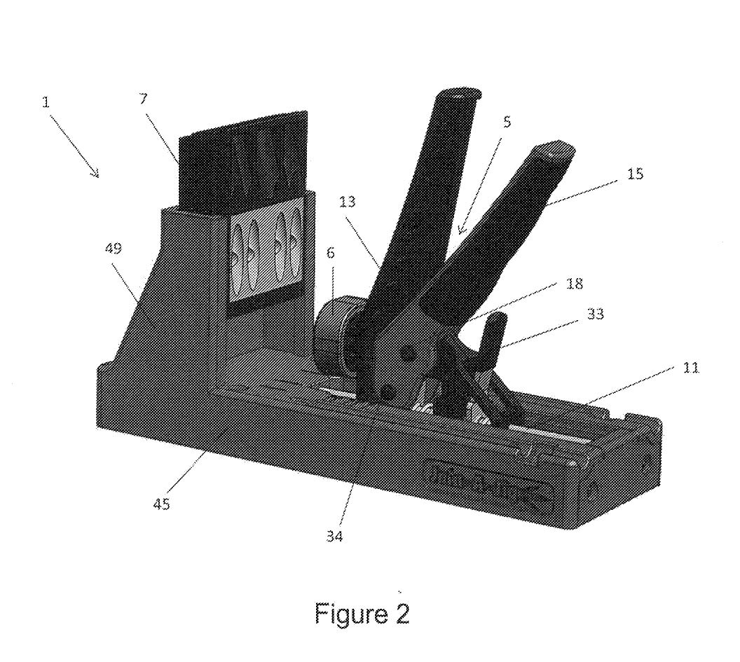

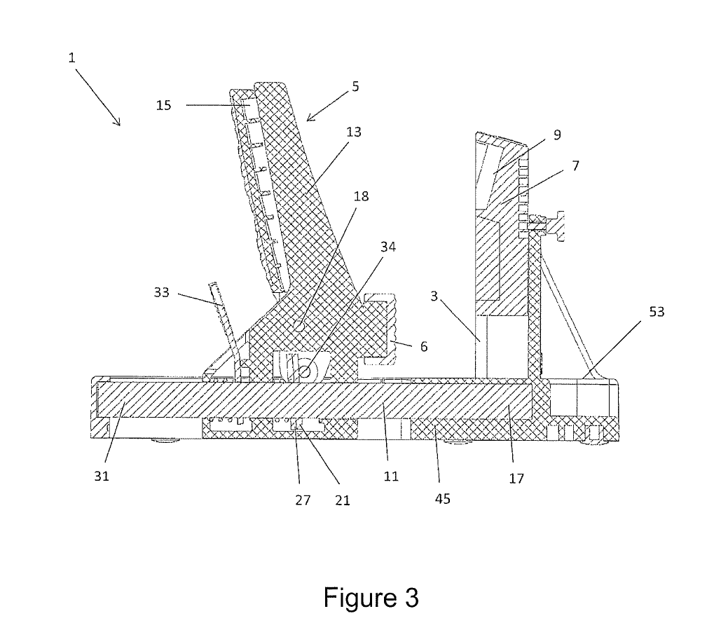

The drilling jig 1 also comprises a drive mechanism 21. Referring now to FIGS. 1-3, the drive mechanism will be described in further detail. The drive mechanism 21 is able to releasably engage the slide bar 11 and cooperate with the handle 15. When the handle 15 is released (as detailed in FIGS. 1 and 2) the drive mechanism 21 is disengaged from the slide bar 11. When the handle 15 is pivoted by the pivoting force (as detailed in FIG. 3), the drive mechanism 21 is caused by the handle 15 to engage with the slide bar 11 whereby the clamping body 13 is caused to be advanced towards the first end 17 of the slide bar 11. This mechanism thus provides a very easy and intuitive means of driving the clamping handle 5.

The drive mechanism 21 is located (i.e. concealed and protected) within a first cavity 23 in the clamping body 13. The drive mechanism 21 comprises a spring 25 and one or more friction plates 27.

Referring now to FIGS. 1, 4 and 6, the friction plates and their cooperation with the handle 15 will be described in further detail. The friction plates comprise an opening 32 for receiving the slide bar 11. Cooperation between the handle 15 and the drive mechanism 21 is via pin 34. Pin 34 is placed between the openings 36 and 38 in the handle 15. When the handle 15 is pivoted, the pin 34 pivots against the upper leaf 40 of the friction plates 27. This pivoting action forces the upper edge 57 and the lower edge 59 of the opening 32 into frictional engagement with the slide bar 11. The spring 25 is arranged to bias the plates 27 out of frictional engagement with the slide bar 11. The spring 25 is displaceable such that, when the handle 15 is pivoted, the upper 57 and lower 59 edges of the opening 32 in the friction plates 27 are brought into engagement with the slide member 11 as previously described.

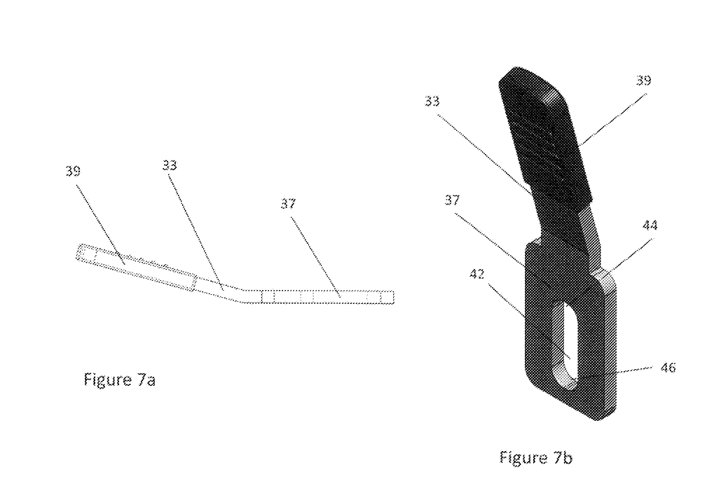

The drilling jig 1 further comprises a stop mechanism 29. Referring now to FIGS. 1 and 7, the stop mechanism 29 will be described in further detail. The stop mechanism 29 is configured to engage with the slide bar 11 so as to resist movement of the clamping handle 5 towards a second end 31 of the slide bar 11. The resistance to movement facilitates the clamping of an object between the upstand 3 and the clamping handle 5. For example, when an object is clamped between the upstand 3 and the clamping handle 5, the stop mechanism 29 prevents the clamping handle 5 from sliding towards the second end 31 of the slide bar 11. This effectively maintains a clamping force between the clamping handle 5 and the upstand 3 such that an object clamped between them is prevented from moving.

The drilling jig 1 also comprises a release mechanism 33 arranged to act on the stop mechanism 29. When the release mechanism 33 is actuated it causes the stop mechanism 29 to disengage from the slide bar 11 so that movement of the clamping handle 5 towards the second end 31 is enabled.

The stop mechanism 29 comprises a spring 35 and a clutch plate 37, and the release mechanism 33 comprises an extension 39 of the clutch plate 37 and a pivot 41. The spring 35 is arranged to bias the clutch plate 37 into frictional engagement with the slide bar 11 to prevent movement of the clamping handle 5 towards the slide bar second end 31. The clutch plate 37 includes an opening 42 for receiving the slide bar 11. When the clutch plate 37 is in frictional engagement with the slide bar 11, the upper 44 and lower 46 edges of the opening 42 are in contact with the slide bar 11.

The spring 35 is displaceable by pivotal movement of the clutch plate extension 39 about the pivot 41. When the clutch plate 37 is released from frictional engagement with the slide bar 11 it allows for movement of the clamping handle 5 towards the slide bar second end 31. The release mechanism 33 is arranged such that, when actuated, it causes the stop mechanism 29 to pivot out of engagement with the slide bar 11 to allow for movement of the clamping handle 5 towards the second end 31 of the slide bar 11.

The stop mechanism 29 is located (i.e. concealed and protected) within a second cavity 43 in the clamping body 13. A user may actuate the release mechanism 33 by gripping the clutch plate extension 39 and the clamping handle 5 in one hand and then squeeze the two together. This effectively releases the stop mechanism 29 such that an object clamped between clamping handle 5 and the upstand 3 is able to be released, moved or repositioned. In the disengaged position, the upper 44 and lower 46 edges of the opening 42 are not in frictional engagement with the slide bar 11.

As previously described, the drilling jig 1 also comprises a guide member 7 with at least one channel 9 for receiving a drill bit. The guide member may also include one, two, three, four or five channels. The channels are angularly disposed within the guide such that a drill bit is directed towards an object clamped between the clamping handle 5 and the upstand 3. The angular channels allows for angular drilling in the clamped object. When the clamped object is a piece of wood, the angular drilling of holes in the wood is useful for drilling holes such that two pieces of wood may be fixed together at right angles.

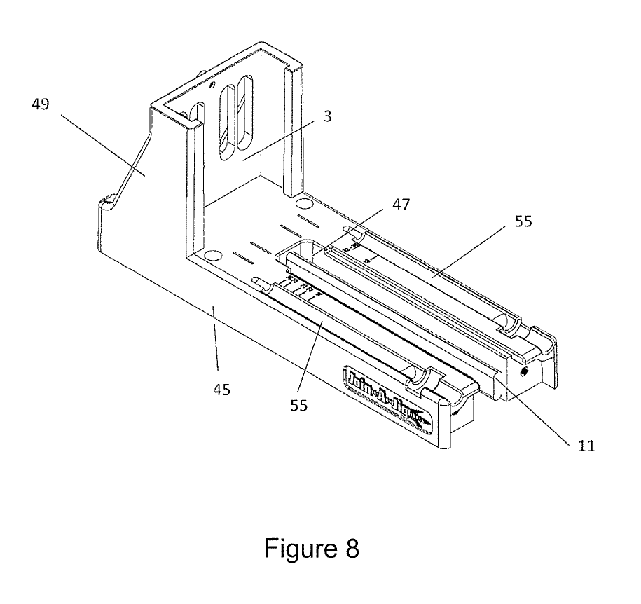

The drilling jig 1 further comprises a base 45 for location on a surface. Referring now to FIG. 8, the base will be described in more detail. The base 45 is flat on the underside such that the drilling jig 1 can be positioned on a surface, such as a workbench. The base 45 comprises a recess 47, the slide bar 11 being located within the recess. The positioning of the slide bar 11 within the recess 47 decreases the overall height and size of the drilling jig 1. The upstand 3 comprises a projecting wall 49 upstanding from the base 45. The projecting wall 49 and base 45 are integral with one another, formed of plastic in a single mould.

The guide member 7 is adjustably mounted to the projecting wall 49 whereby the height of a lower exit end 51 (see FIG. 1) of the channel 9 can be moved with respect to the base. This allows for the height of the hole drilled in the clamped piece of wood to be adjusted.

Referring now to FIG. 8, the base will be described in more detail. The base also comprises a clamping surface 53 to allow for the drilling jig 1 to be clamped to a work surface (e.g. workbench). Clamping the drilling jig 1 to a work surface prevents movement of the drilling jig when a user is drilling angular holes in object clamped between the clamping handle 5 and the upstand 3. The base also comprises one or two more recesses 55 for holding the drill bit. The drill bit snap-fits into the recess 55 such that the drill bit is able to be kept with the drilling jig 1 when the drilling jig 1 is not being used.

In the claims which follow and in the preceding description, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the clamping device.

1. A clamping device comprising:
a first member;
a second member being mounted to a slide bar and slideably movable with respect to the first member, the first and second members configured such that in use an object is able to be clamped between them; and
a guide member comprising at least one channel for receiving a drill bit, the channel able to direct the drill bit to the object when clamped between the first and second members;
the second member comprising a clamping body and a handle, the handle being pivotally mounted to the clamping body such that a pivoting force applied to the handle causes the second member to slide along the slide bar towards a first end of the slide bar.

2. A device according to claim 1, the clamping device further comprises a drive mechanism, the drive mechanism able to releasably engage the slide bar and cooperating with the handle such that:
when the handle is released the drive mechanism is disengaged from the slide bar;
when the handle is pivoted by the pivoting force, the drive mechanism is caused by the handle to engage with the slide bar whereby the clamping body is caused to be advanced towards the first end of the slide bar.

3. A device according to claim 2, wherein the drive mechanism is located within a first cavity in the clamping body.

4. A device according to claim 2, wherein the drive mechanism comprises a spring and one or more friction plates, the spring arranged to bias the plates out of frictional engagement with the slide bar, the spring being displaceable such that, when the handle is pivoted, the friction plates are brought into engagement with the slide bar.

5. A device according to claim 1, wherein the clamping device further comprises a stop mechanism that is configured to engage with the slide bar so as to resist movement of the second member towards a second end of the slide bar, this resistance to movement facilitating clamping of the object between the first and second members.

6. A device according to claim 5, wherein the clamping device further comprises a release mechanism arranged to act on the stop mechanism whereby, when the release mechanism is actuated it causes the stop mechanism to disengage from the slide bar so that movement of the second member towards the second end is enabled.

7. A device according to claim 6, wherein the stop mechanism comprises a spring and a clutch plate, and the release mechanism comprises an extension of the clutch plate and a pivot, the spring arranged to bias the clutch plate into frictional engagement with the slide bar to prevent movement of the second member to the slide bar second end, the spring being displaceable by pivotal movement of the clutch plate extension about the pivot whereby the clutch plate is released from frictional engagement with the slide bar so as to allow the movement of the second member to the slide bar second end.

8. A device according to claim 6, wherein the release mechanism is arranged such that, when actuated, it causes the stop mechanism to pivot out of engagement with the slide bar to allow for movement of the second member towards the second end of the slide bar.

9. A device according to claim 6, wherein the stop mechanism is located within a second cavity in the clamping body.

10. A device according to claim 1, wherein the at least one channel is angularly disposed within the guide member.

11. A device according to claim 1, wherein the clamping device further comprises a base for location on a surface.

12. A device according to claim 11, wherein base comprises a recess, the slide bar being located within the recess.

13. A device according to claim 11, wherein the guide member is adjustably mounted to the projecting wall whereby the height of a lower exit end of the at least one channel can be moved with respect to the base.

14. A device according to claim 11, wherein the first member comprises a projecting wall upstanding from the base.

15. A device according to claim 11, wherein the base comprises a clamping surface to allow for the clamping device to be clamped to a work surface.

16. A device according to claim 11, wherein the base comprises another recess for holding the drill bit.
